(19) United States
(12) Patent Application Publication
(10) Pub. No.: US 2017/0205535 A1
(43) Pub. Date: Jul. 20, 2017

(54) WEARABLE RADAR DETECTION DEVICE

(71) Applicant: Honeywell International Inc., Morris Plains, NJ (US)

(72) Inventors: Guoqing Wang, Beijing (CN); Yong Yi, Shanghai (CN); Jeffrey A. Hester, Oro Valley, AZ (US); Qingshuang Zeng, Beijing (CN); Xiaodong Chen, Shanghai (CN); Lexin Hu, Shanghai (CN)

(21) Appl. No.: 15/000,937

(22) Filed: Jan. 19, 2016

(51) Int. Cl. G01W 1/00; G08B 21/18

(52) U.S. Cl. CPC G01W 1/00; G08B 21/18

(57) ABSTRACT

An actively powered wearable weather radar detection device may include a battery, at least one microstrip antenna, and a microcontroller electrically coupled to the battery and the at least one microstrip antenna. The microstrip antenna may be configured to receive a weather radar signal from an airplane, convert the weather radar signal into an electrical signal, and output the electrical signal. The microcontroller may be configured to determine, based on the electrical signal, whether to output an alert signal, and responsive to determining to output an alert signal, send a command signal to an alert device causing the alert device to output the alert signal.

### TECHNICAL FIELD

The disclosure relates to radar detection systems.

### BACKGROUND

An aircraft may include onboard radar systems to detect adverse weather conditions or nearby aircraft. Aircraft personnel onboard the plane, such as a pilot, may manually activate and deactivate radar. For example, a pilot may active the radar upon takeoff and may deactivate the radar upon touchdown. If the radar is not deactivated, ground personnel may be subject to radar signals.

### SUMMARY

In one example, an actively powered wearable weather radar detection device may include a battery, at least one microstrip antenna, and a microcontroller. The at least one microstrip antenna may be configured to receive a weather radar signal from an airplane, convert the weather radar signal into an electrical signal, and output the electrical signal. The microcontroller may be electrically coupled to the battery and the at least one microstrip antenna. The microcontroller may be configured to determine, based on the electrical signal, whether to output an alert signal, and responsive to determining to output an alert signal, send a command signal to an alert device causing the alert device to output the alert signal.

In one example, a passively powered wearable weather radar detection device may include at least one microstrip antenna and a light source electrically coupled to the at least one microstrip antenna. The at least one microstrip antenna may be configured to receive a weather radar signal from an airplane, convert the weather radar signal into an electrical signal, and output the electrical signal. The light source may be configured to output, based on the electrical signal, a light visible by a person within the airplane. The light source may be powered solely by the electrical signal.

In one example, a method may include receiving, by a microstrip antenna, a weather radar signal from an airplane. The method may also include converting, by the microstrip antenna, the weather radar signal into an electrical signal and outputting, by the microstrip antenna, the electrical signal. The method may further include determining, by a microcontroller and based on the electrical signal, whether to output an alert signal. The method may also include responsive to determining to output an alert signal, sending a command signal to an alert device causing the alert device to output the alert signal.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a conceptual block diagram illustrating an example radar detection system, in accordance with various aspects of this disclosure.

FIG. 2 is a conceptual block diagram showing an example wearable radar detection device, in accordance with various aspects of this disclosure.

FIG. 3 is a circuit diagram illustrating an example implementation of wearable radar detection device, in accordance with various aspects of this disclosure.

FIG. 4 is a circuit diagram illustrating an example implementation of wearable radar detection device, in accordance with various aspects of this disclosure.

FIG. 5 is a flowchart illustrating an example method for detecting weather radar, in accordance with various aspects of this disclosure.

### DETAILED DESCRIPTION

Airline pilots and technicians often express concern about radio frequency (RF) radiation, particularly with respect to the weather radar. Even though standard airport operating procedures recommend turning radar systems off when an aircraft is on the ground, pilots occasionally forget to turn the radar systems off. As a result, ground crew personnel working around the plane may be subjected to radar signals, which may cause harmful effects to the ground personnel. In addition to thermal effects caused by RF (also referred to as microwave radiation), recent research suggests that non-thermal effects may also occur. The phenomenon of RF “hearing” has been reported and verified. Alterations in animal behavior patterns following RF microwave radiation exposure have been observed. Effects on the immune response system and on the central nervous system are receiving considerable attention. Efforts continue to determine if these subtle and usually reversible changes have any public health significance. Even if the RF radiation does not cause harmful effects to the body of the ground crew, ground crew may worry about the exposure to the RF radiation, which may cause mental suffering.

In general, this disclosure describes devices and methods for detecting weather radar signals emitted by an aircraft and outputting one or more alert signals to alert persons onboard the aircraft or ground personnel that the aircraft radar system is active. The described devices may be wearable, which may require the device to be smaller and consume less power than other radar detection devices. In addition, the described devices and methods may alert not only the user of the device to potential radar signals, but may also alert other ground personnel or persons within the aircraft that the aircraft radar systems are still active. In this way, ground personnel may position themselves outside the path of the radar signals and aircraft personnel may turn off the radar system.

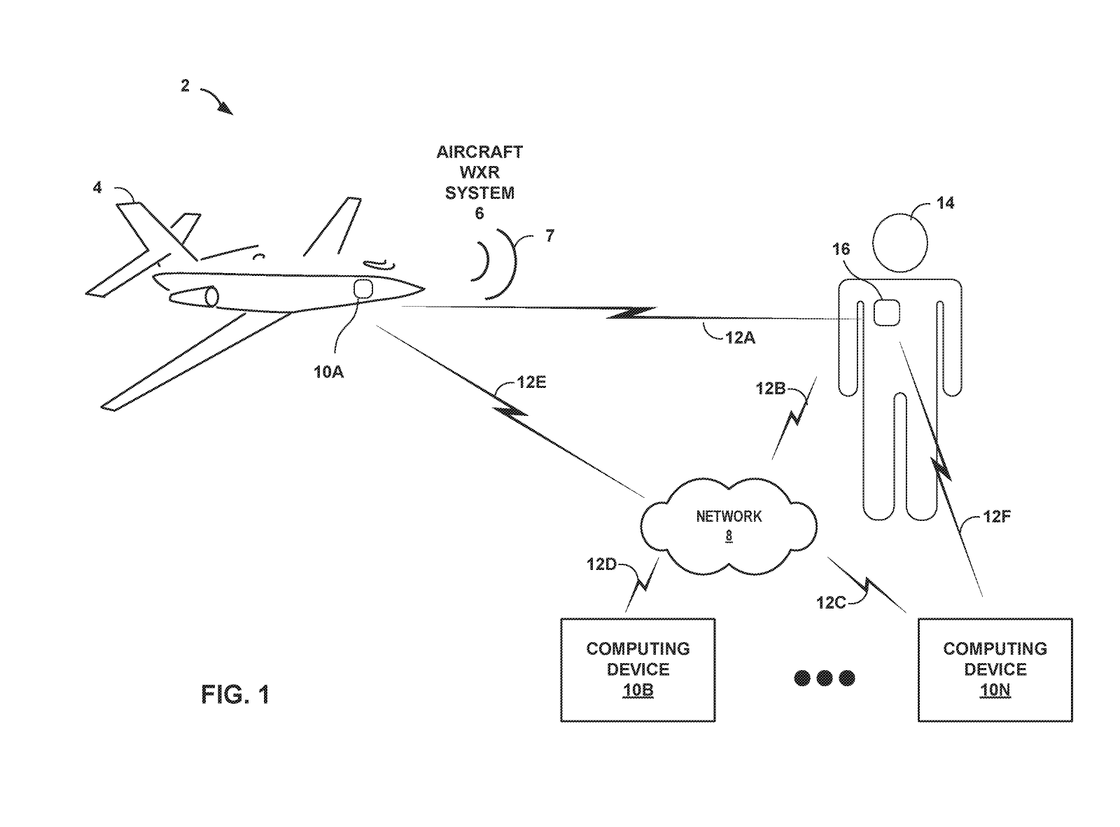

FIG. 1 is a conceptual block diagram illustrating an example radar detection system 2, in accordance with various aspects of this disclosure. System 2 includes aircraft 4, aircraft weather radar system 6 (hereinafter, aircraft WXR system 6), network 8, remote computing devices 10A-10N (collectively, remote computing devices 10), network links 12A-12E (collectively, network links 12), and wearable radar detection device 16.

Aircraft 4 may be any aircraft (e.g., commercial, military, or personal) equipped with onboard radar systems for detecting weather, other aircraft, etc. For example, aircraft 4 may be equipped with onboard aircraft WXR system 6 that is configured to transmit radar signal 7 and receive a radar return signal that has deflected off some structure (e.g., convective weather structure and/or ground structure). In some examples, radar signal 7 may include a waveform and a plurality of coherent pulses, which may be emitted with a frequency of approximately 9 GHz (plus or minus approximately 500 MHz).

Computing devices 10 may represent any type of computing device, such as a laptop computer, desktop computer, server, smartphone, so called “smartwatch,” so called “fitness tracker,” television, electronic billboard, or the like. Computing devices 10 may be different types of computing devices. For example, aircraft 4 may include an onboard computing device 10A, which may be configured to process a radar return signal and display radar information to a pilot of aircraft 4.

Computing devices 10 may be communicatively coupled to network 8 via network links 12. Network 8 may represent any type of communication network such as a cellular network, WiFi, or the like. Computing devices 10 may send data to and receive data from other computing devices 10 across network 8. For example, computing device 10A (e.g., an onboard computing device) may send radar information to computing device 10B (e.g., a server) across network 8 via network links 12. Network links 12 may include any type of network connection such as WiFi, Ethernet, Bluetooth, or any other method of transmitting information over a network. Network links may include wired and/or wireless connections, Computing devices 10 may communicate with one other via different network links. For example, computing device 10A may communicate with computing device 10B over a satellite network while computing device 1013 may communicate with computing device 10N over WiFi.

Wearable radar detection device 16 may be worn by user 14. In some examples, user 14 includes an airport employee, such as ground crew to guide a plane as it enters and exits the gate. Wearable radar detection device 16 may include an employee m badge, head-ware (e.g., a hat), clothing (e.g., a vest), a watch, computing device (e.g., a smartphone), or any other item that may be located on the person of user 14.

Wearable radar detection device 16 may be configured to detect radar signal 7 emitted by aircraft 4. Responsive to detecting radar signal 7, wearable radar detection device 16 may alert user 14 or personnel aboard aircraft 4 that user 14 is within a radar beam being emitted by aircraft WXR system 6, meaning that aircraft WXR system 6 is still active. For example, wearable radar detection device 16 may produce a visual, audible, and/or vibrational alert. For instance, wearable radar detection device 16 may include a light source (e.g., an LED array) to display a visual alert. In some examples, the light source may light up bright enough to be seen by user 14 and/or by a person within aircraft 4. Likewise, wearable radar detection device 16 may include a speaker that may produce an audible alert to inform user 14 that wearable radar detection device 16 has detected radar signal 7.

In some examples, wearable radar detection device 16 may send an alert signal to one or more of computing devices 10. For example, wearable radar detection device 16 may send a message to computing device 10N (e.g., a smartphone) causing computing device 10N to output an alert signal to user 14 that user 14 is in the path of radar signal 7. In some instances, wearable radar detection device 16 may send the message to computing device 10N over network 8 via network links 12. However, in some instances, wearable radar detection device 16 may send the message directly (e.g., via Bluetooth). In some examples, wearable radar detection device 16 may send a message to onboard computing device 10A causing computing device 10A to alert a person within aircraft 4 that aircraft WXR system 6 is active and is emitting radar signals 7. In some examples, wearable radar detection device 16 may send a message to computing device 10B (e.g., an electronic billboard or large monitor outside the airport gate) to alert persons onboard aircraft 4 or ground crew that aircraft WXR system 6 is active. In other example, wearable radar detection device 16 may send a message to computing device 10B (e.g., a computer connected to a speaker system), which may cause computing device 10B to produce an audible alert to alert ground crew that aircraft WXR system 6 is active.

In accordance with techniques described in this disclosure, wearable radar detection device 16 may detect radar signal 7 and alert user 14 that user 14 is positioned in the path of radar signal 7. In addition, wearable radar detection device 16 may alert other ground crew and/or persons onboard aircraft 4 that aircraft WXR system 6 is still active. In this way, user 14 may move out of the path of radar signal 7. In addition, if ground crew personnel see or hear an alert, the ground personnel may notify user 14 and reposition themselves so that user 14 and the ground personnel are riot subject to radar signal 7. Further, persons onboard aircraft 4 may realize that aircraft WXR system 6 is still active and may shut off aircraft WXR system 6. In this manner, all persons involved with system 2 may be protected from any ill effects associated with radar signal 7.

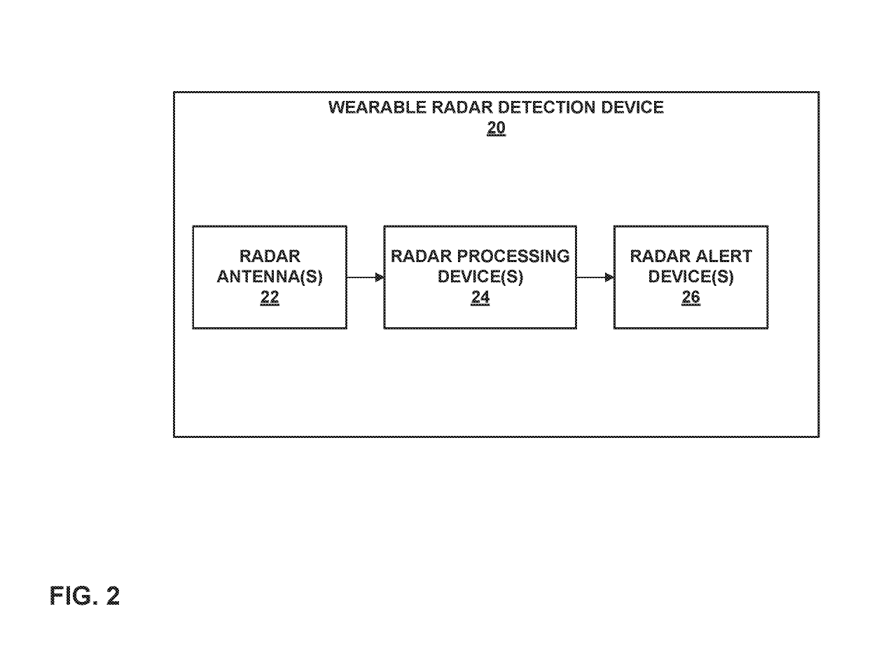

FIG. 2 is a conceptual block diagram showing an example wearable radar detection device 20, in accordance with various aspects of this disclosure. Wearable radar detection device (WRDD) 20 may correspond to WRDD 16 of FIG. 1. WRDD 20 may include one or more radar antennas 22, one or more radar processing devices 24, and one or more radar alert devices 26. FIG. 2. shows WRDD 20 as having separate and distinct components; however, WRDD 20 may include additional or fewer components. For instance, radar antenna 22, radar processing device 24, and radar alert device 26 may be three individual components or may represent a combination of one or more components that provide the functionality of WRDD 20 as described herein.

Each of the one or more radar antennas 22 may include a microstrip antenna. For example, the microstrip antenna may be etched onto a printed circuit board (PCB) or onto a flexible substrate (e.g., a dielectric substrate). Radar antennas 22 may be positioned in a variety of locations and orientations within WRDD 20 to capture radar signal 7 from a variety of angles. In some examples, radar antennas 22 may be circularly polarized. The dimensions of radar antennas 22 may be selected to balance the quality of radar detection with the size of the device. For example, a larger radar antenna 22 may be more likely to capture radar signal 7. However, the size of the radar antenna 22 may be constrained by the size of WRDD 20. In some examples, each radar antenna 22 may include approximately the same dimensions. However, in other examples, one or more of radar antennas 22 may include dimensions different than one or more other radar antennas 22. For purpose of illustration only, in some examples, one or more of radar antennas 22 may be approximately 20 millimeters long by approximately 15 millimeters wide by approximately 3 millimeters thick. In some examples, one or more of radar antennas 22 may be approximately 20 millimeters long by approximately 10 millimeters wide by approximately 1 millimeter thick. However, in other examples, one or more of radar antennas 22 may include different dimensions. The upper limit of the antenna dimensions may be constrained only by the size of WRDD 20. In some examples, several radar antennas 22 may be arranged to create an antenna. array in order to improve detection of a radar signal.

In some examples, each radar antenna 22 may be configured to detect radio waves in the “X-band”, which may be defined by frequencies of approximately 8 GHz to approximately 12.5 GHz. In some instances, each radar antenna 22 may be configured to detect radio waves in a subset of the X-band. For example, each radar antenna 22 may be configured to detect weather radar signals with a frequency of approximately 9 GHz. In some examples, one or more of radar antennas 22 may be configured to detect radio waves in other radar bands, such as the Ka-band (approximately 26.5 GHz to approximately 40 GHz), the K-band (approximately 18 GHz to approximately 26.5 GHz), the Ku-band (approximately 12.5 GHz to approximately 18 GHz), the C band (approximately 4 GHz to approximately 8 GHz), the S-band (approximately 2 GHz to approximately 4 GHz), or the L-band (approximately 1 GHz to approximately 2 GHz). In some examples, one or more of radar antennas 22 may include an ultra-wideband radar antenna configured to detect radio waves across one or more of the radar bands described above.

Radar antenna 22 may receive radar signal 7 and may convert the received radar signal 7 into an electrical signal (e.g., AC voltage or current). One or more radar processing devices 24, which may be electrically coupled to the one or more radar antennas 22, may process the electrical signal generated by radar antenna 22. For example, each radar processing device 24 may include a filter to attenuate electrical signals with a certain frequency and/or amplifier to increase the magnitude of the electrical signal. Each radar processing device 24 may convert the electrical signal from AC to DC and may output the filtered and/or amplified DC electrical signal.

One or more radar alert devices 26 may be electrically coupled to the one or more radar processing devices 24. Radar alert devices 26 may receive the electrical signal from one or more radar processing device 24. For instance, radar alert device 26 may output a visual alert signal (i.e., light) which may indicate to the user 14 or a person within aircraft 4 that the radar system is still active. As another example, radar alert device 26 may output an audio alert signal (i.e., sound) which may indicate to the user 14 that the radar system is still active. As yet another example, radar alert device 26 may output a vibrational alert signal (e.g., by vibrating).

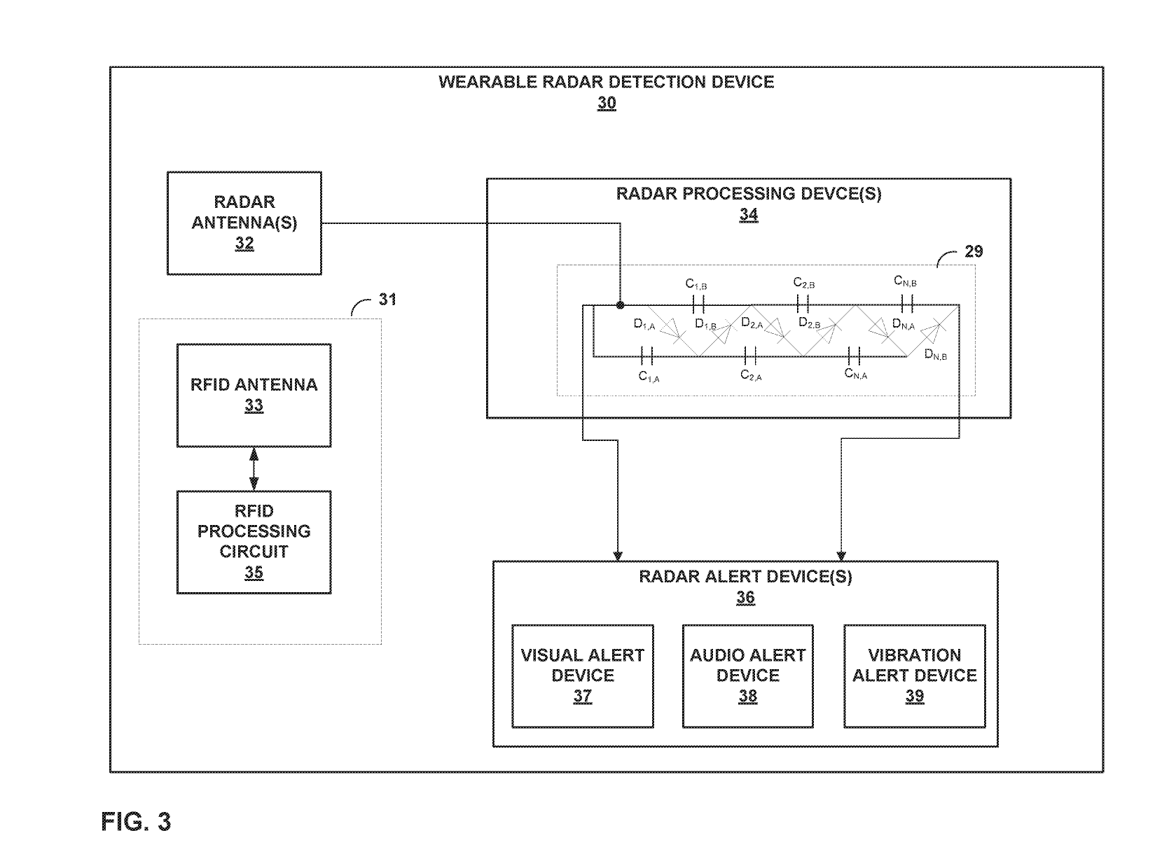

FIG. 3 is a circuit diagram illustrating an example implementation of wearable radar detection device 16, in accordance with various aspects of this disclosure. WRDD 30 may correspond to WRDD 20 of FIG. 2. FIG. 3 illustrates only one particular example of WRDD 30 and many other examples of WRDD 30 may be used in other instances. Other examples of WRDD 30 may include a subset of the components shown in FIG. 3 and/or may include additional components not shown in FIG. 3. The components illustrated in FIG. 3 may be individual components or may represent a combination of one or more components that provide the functionality of WRDD 30 as described herein.

WRDD 30 may include RFID device 31, one or more radar antennas 32, one or more radar processing devices 34, and one or more radar alert devices 36. RFID device 31 may include RFID antenna 33 and RFID processing circuit 35. RFID antenna 33 may be electrically coupled to RFID processing circuit 35. RFID processing circuit 35 may include information (e.g., employee information) encoded on a processing chip (also called an RFID tag). In some examples, RFID device 31 may be passively powered. For example, RFID antenna 33 may receive energy from a remote device (e.g., electromagnetic waves from an RFID reader) that induces a current in RFID antenna 33, which may power RFID processing circuit 35. Responsive to receiving current from MP antenna 33, RFID processing circuit 35 may transmit information stored on the RFID tag to the remote device via RFID antenna 33.

The one or more radar antennas 32 may be substantially similar to the one or more radar antennas 22 of FIG. 2. In some examples, each of the one or more radar antennas 32 may be electrically coupled to a respective radar processing device 34. However, in some examples, each of the one or more radar antennas 32 may be electrically coupled to a single radar processing device 34.

In some examples, the one or more radar processing devices 34 receive an electrical signal from one or more radar antennas 32 and may amplify the electrical signal. For example, the one or more radar processing devices 34 may include an N-stage voltage multiplier 29, where N is any positive integer greater than or equal to two. N-stage voltage multiplier 29 may amplify the input voltage and convert the AC voltage to a DC voltage. N-stage voltage multiplier 29 may amplify the peak AC voltage to a DC voltage approximately N-times greater than the peak AC voltage. For example, if N-stage voltage multiplier 29 includes a 3-stage voltage multiplier and radar antenna 32 outputs a peak AC voltage of 1V, N-stage voltage multiplier 29 may output a DC voltage of approximately three volts. In some examples, the output voltage is not exactly N-times the input voltage (e.g., due to impedance in the multiplier). In sonic examples, N-stage voltage multiplier 29 may convert the input. AC electrical signal to a DC electrical signal. In some examples, each stage of N-stage voltage multiplier 29 include two diodes D_{N,A} and D_{N,B} and two capacitors C_{N,A} and C_{N,B}. For example, as shown in FIG. 3, voltage multiplier 29 includes a 3-stage voltage multiplier. The first stage of three-stage multiplier 29 includes diodes D_{1,A} and D_{1,B} and capacitors C_{1,A} and C_{1,B}. In some examples, N-stage voltage multiplier may output the amplified electrical signal to power one or more radar alert devices.

WRDD 30 may include one or more radar alert devices 36 electrically connected to one or more radar processing devices 34. The one or more radar alert devices 36 may output an alert signal in response to receiving an electrical signal from radar processing device 34. In some examples, the one or more radar alert devices 36 may include visual alert device 37, audio alert device 38, vibrational alert device 39, or any combination thereof. The one or more alert devices 36 may output different types of alert signals. For instance, visual alert device 37 may output a visual alert signal (e.g., light), audio alert device 38 may output an audio alert signal (e.g., sound), and vibrational alert device 39 may output a vibrational alert signal (e.g., by vibrating) In some examples, WRDD 30 may include a passively powered wearable radar detection device. In other words, in some examples, the one or more radar alert devices 36 do not receive power from a battery but are instead powered solely by energy received from radar signal 7.

Visual alert device 37 may include a light source which may output a visual alert signal. For example, the light source may include an LED array which may output light. In some instances, the LED array may flash (i.e., alternate between on/off in a rapid sequence) to help draw attention to the visual alert signal. In some examples, WRDD 30 may include an array of LEDs arranged along the perimeter of WRDD 30. For example, in an example where WRDD 30 includes an employee ID badge approximately 50 millimeters by approximately 90 millimeters (or approximately 2.125 inches by approximately 3.375 inches). In some examples, the employee ID badge may include an array of LEDs arranged along all four edges of a front surface of the employee ID badge to create a border around the employee ID badge. For instance, the LED array may create a border around the perimeter of the employee ID badge. In some examples, the border LED array may be sufficiently large that the visual alert signal may be visible from a large distance (e.g., by personnel within aircraft 4 or other airport ground personnel). For example, the border LED array may be approximately 12.5 millimeters (approximately 0.5 inches) around all four edges of the front surface of the badge. In other examples, an LED array may form a particular shape to warn that the radar system is active, such as an octagon (e.g., to mimic a stop sign), an “X”, an exclamation point, any alphanumeric character, or any other shape. In some examples, WRDD 30 may include a light source on more than one surface. For example, if WRDD 30 includes an employee ID badge, WRDD 30 may include a light source on the front surface, back surface (e.g., in case the badge gets flipped over), top surface, bottom surface, and/or one or more side surfaces in order to make an alert signal more visible regardless of the orientation of WRDD 30. In some examples, WRDD 30 may include an article of clothing with an embedded LED array, such as a vest with an LED array on the front and back, a hat with an LED array that encircles the hat, or a watch with an LED display. In some examples, WRDD 30 may include a sticker that may be positioned in various locations on an article of clothing. For instance, multiple WRDD 30 stickers may be positioned at different positions on an employee uniform to increase the probability of detecting radar signals 7.

Audio alert device 38 may include a speaker and which may generate an audio alert signal. For example, audio alert device 38 may generate a series of beeps or an audio message indicating that user 14 is in the path of radar signal 7. In some examples, audio alert device 38 may include a headphone jack (e.g., a 3.5 millimeter port to connect to set of headphones to WRDD 30). Vibrational alert device 39 may output a vibrational alert signal. For example, vibrational alert device 39 may include a small motor and a small weight set slightly off-center which may cause WRDD 30 to vibrate in response to receiving a voltage from radar processing device 34. In some examples, the intensity of the alert signal may be proportional to the amount of energy received from radar signals 7. For example, the luminosity of the light emitted by an LED array, the loudness of an audio signal emitted by a speaker, or the force of vibration may be proportional to the energy received from radar signals 7.

In operation, one or more radar antennas 32 (e.g., a microstrip antenna) may detect a radar signal 7 (i.e., electromagnetic energy) generated by a radar emitter (e.g., aircraft WXR system 6). The one or more radar antennas 32 may receive the radar signal and convert the received energy to an AC electrical signal (e.g., an AC voltage or current). Radar processing device 34 may receive the AC electrical signal. In some examples, one or more radar processing devices 34 may amplify the magnitude of the electrical signal and convert the AC electrical signal to a DC electrical signal. Radar processing devices 34 may output the amplified DC electrical signal.

The one or more radar alert devices 36 may be electrically coupled to one or more radar processing devices 34. One or more radar alert devices 36 may receive the DC electrical signal from radar processing devices 34, which may power the one or more radar alert devices 36. The one or more radar alert devices 36 may emit an alert signal. For example, visual alert device 37 (e.g., a light source) may receive the DC electrical signal which may cause visual alert device 37 to output a visual alert signal (e.g., outputting light via an LED array). In another example, audio alert device 38 may receive the DC electrical signal which may cause audio alert device 38 to output an audio alert signal (e.g., an alert tone, series of beeps, etc.). In yet another example, vibrational alert device 39 may receive the DC electrical signal which may cause vibrational alert device 39 to output a vibrational alert signal (e.g., by vibrating).

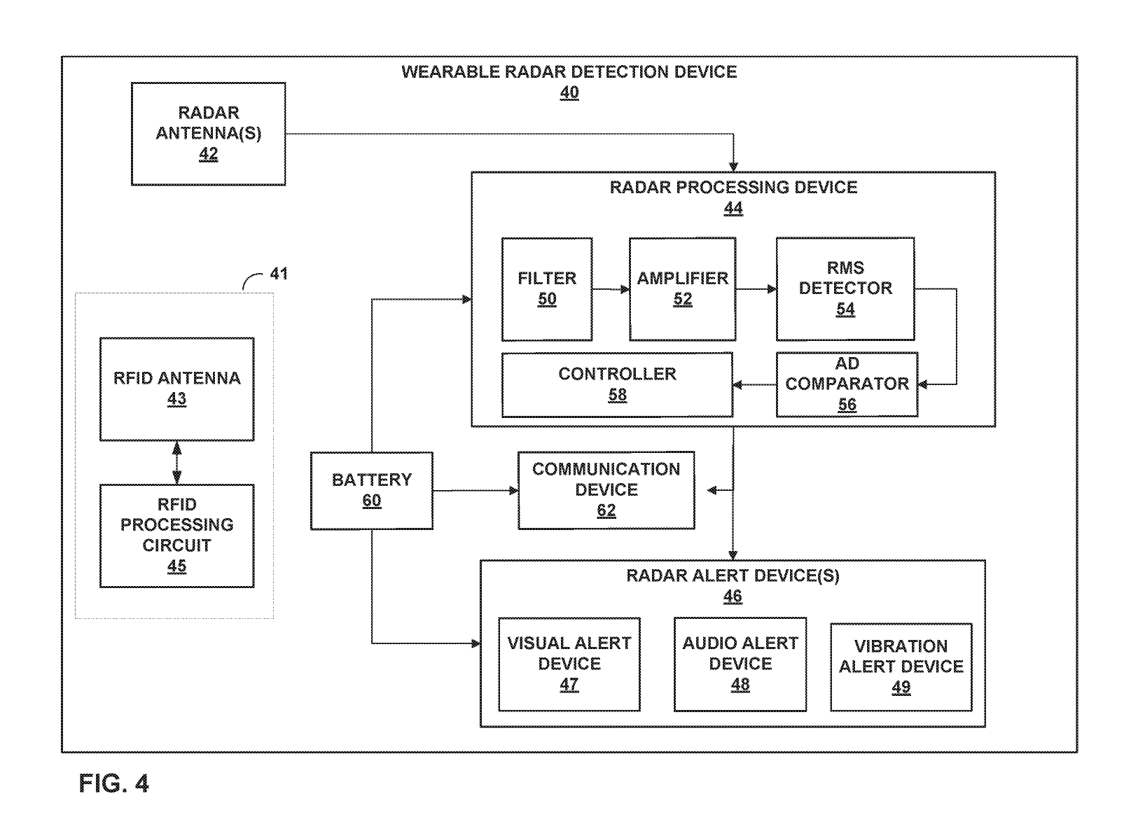

FIG. 4 is a circuit diagram illustrating an example implementation of wearable radar detection device 16, in accordance with various aspects of this disclosure. WRDD 40 may correspond to WRDD 20 of FIG. 2. FIG. 4 illustrates only one particular example of WRDD 40 and many other examples of WRDD 40 may be used in other instances. Other examples of WRDD 40 may include a subset of the components shown in FIG. 4 and/or may include additional components not shown in FIG. 4. The components illustrated in FIG. 4 may be individual components or may represent a combination of one or more components that provide the functionality of WRDD 40 as described herein.

WRDD 40 may include RFID device 41, one or more radar antennas 42, radar processing device 44, one or more radar alert components 46, battery 60, and communication device 62. In some examples, RFID device 41 may be substantially similar to RIM device 31 described with reference to FIG. 3. Likewise, the one or more radar antennas 42 may be substantially similar to the one or more radar antennas 32 described with reference to FIG. 3.

Radar processing device 44 may be electrically coupled to one or more radar antennas 42 and may receive an electrical signal (e.g., AC voltage or current) from one or more radar antennas 42. Radar processing device 44 may include filter 50, amplifier 52, root-mean-squared (RMS) power detector 54, comparator 56, and controller 58. Filter 50 may include a microstrip filter (e.g., a filter etched onto a printed circuit board (PCB) or onto a flexible substrate such as a dielectric substrate), such as a high-pass filter, low-pass filter, or bandpass filter. Filter 50 may attenuate electrical signals with a frequency that does not fall within a predetermined threshold frequency (e.g., is less than a threshold frequency, greater than a threshold frequency, or does not fall within a range determined by a first threshold frequency and a second threshold frequency). Amplifier 52 may include one or more transistor-based amplifiers, operational amplifiers, or any other type of amplification circuitry. In some examples, amplifier 52 includes a low noise amplifier (LNA). Amplifier 52 may receive an AC electrical signal from one or more radar antennas 42 (via filter 50), amplify the AC electrical signal, and output the amplified AC electrical signal. Root-mean-square (RMS) power detector 54 may receive the amplified AC electrical signal from amplifier 52, convert the AC electrical signal to a DC electrical signal, and output the amplified DC electrical signal. AD Comparator 56 may receive the DC electrical signal, convert the DC electrical signal to a digital value, and output the digital value to controller 58.

Controller 58 may include at least one processor and at least one memory device. The processor, as well as other processors described in this disclosure, may include one or more digital signal processors (DSPs), general purpose microprocessors, application specific integrated circuits (ASICs), field programmable logic arrays (FPGAs), or other equivalent integrated or discrete logic circuitry, or combinations thereof. The functions attributed to the controllers and processors described herein may be provided by a hardware device and embodied as software, firmware, hardware, or any combination thereof.

The one or more memory devices described herein may include any one or more volatile or non-volatile media, such as a random access memory (RAM), read only memory (ROM), non-volatile RAM (NVRAM), electrically erasable programmable ROM (EEPROM), flash memory, and the like. The one or more memory devices may store computer-readable instructions that, when executed by the one or more processors cause controller 58 to perform various functions described herein.

Controller 58 may include a microcontroller electrically coupled to AD comparator 56. In some examples, controller 58 may receive the digital value from AD comparator 56 and determine whether to output an alert signal based on the digital value. For example, controller 58 may determine whether to output a visual alert signal, audio alert signal, vibrational alert signal, or any combination thereof. Responsive to determining to output an alert signal, controller 58 may send a command signal to one or more radar alert devices 46, which may cause the one or more radar alert devices 46 to output an alert signal.

Radar alert devices 46 may include visual alert device 47, audio alert device 48, vibrational alert device 49, or any combination thereof. In some examples, visual alert device 47 may be substantially similar to visual alert device 37 described with reference to FIG. 3. Likewise, audio alert device 48 may be substantially similar to audio alert device 38 and vibrational alert device 49 may be substantially similar to vibrational alert device 49, as respectively described with reference to FIG. 3.

One or more radar alert devices 46 may be electrically coupled to controller 58 and may receive a command signal from controller 58. Responsive to receiving a command signal from controller 58, the one or more radar alert device 36 may output an alert signal. For instance, visual alert device 47 may output a visual alert signal similar to the visual alert signals described with reference to FIG. 3, audio alert device 48 may output an audio alert signal similar to the audio alert signals described with reference to FIG. 3, and/or vibrational alert device 49 may output a vibrational alert signal similar to the vibrational alert signal described with reference to FIG. 3.

In some examples, WRDD 40 may include one or more communication devices 62. Communication devices 62 may communicate with external devices via one or more networks by transmitting and/or receiving network signals on the one or more networks. For example, WRDD 40 may use communication devices 62 to transmit and/or receive radio signals on a radio network such as a cellular radio network, WiFi network, or the like. Examples of communication devices 62 may include a network interface card (e.g., an Ethernet card), wireless Ethernet network radios (e.g., WiFi), cellular data radios, as well as universal serial bus (USB) controllers, optical transceivers, radio transceivers, or the like.

The one or more communications devices may be electrically coupled to controller 58. Controller 58 may send an command signal to communication devices 62 causing communication devices 62 to transmit a message to one or more computing devices 10 indicating that WRDD 40 has received radar signals 7. The message may cause one or more computing devices 10 to output an alert signal. For example, communication device 62 may send a message (e.g., via network 8) to computing device 10A of FIG. 1 causing computing device 10A to output an alert signal to inform persons within aircraft 4 that aircraft WXR system 6 is still active. In this way, persons within aircraft 4 may see that aircraft WXR system is still active and may shut it off. In some examples, communication device 62 may send a message directly (e.g., via Bluetooth) to computing device 10N (e.g., a smartphone) to inform user 14 that user 14 is within the path of radar signals 7. In sonic examples, communication device 62 may send a message to computing device 10B which may cause computing device 10B to output a visual alert (e.g., via an electronic display) or an audio alert (e.g., via a speaker system) to inform user 14 or other ground personnel that aircraft WXR system 6 is still active. In this way, user 14 or other ground personnel may see that aircraft WXR system is still active and may position themselves out of the path of radar signals 7.

In some examples, WRDD 40 may include an actively powered wearable radar detection device 40. In other words, battery 60 may be electrically coupled to radar processing device 44, radar alert devices 46, communication device 62, or any combination thereof such that the devices 44, 46, and/or 62 may be powered at least in part by battery 60. Battery 60 may be removable. Battery 60 may be rechargeable. For instance, user 14 may remove battery 60 from WRDD 40 in order to recharge battery 60. However, in some instances, battery 60 may include rechargeable without removing battery 60. For example, WRDD 40 may include a connection device (e.g., a micro-USB port) which may enable battery 60 to be charged without removing battery 60. In some examples, battery 60 may be wirelessly charged (e.g., via inductive charging).

In operation, one or more radar antennas 42 may receive radar signals 7 and may convert radar signals 7 to an electrical signal (e.g., an AC voltage or current). Radar processing device 44 may receive the electrical signal from radar antennas 42. Filter 50 may attenuate electrical signals with a frequency that do not meet a threshold frequency. Amplifier 52 may amplify the electrical signal that passes through filter 50. RMS detector 54 may convert the electrical signal from an AC electrical signal to a DC electrical signal. AD comparator may convert the DC electrical signal from an analog signal to a digital electrical signal. Controller 58 may receive the digital electrical signal.

In some examples, controller 58 may determine whether to output an alert signal based on the digital electrical signal. Responsive to determining to output an alert signal, controller 58 may send a command signal to one or more radar alert devices 46, which may cause the one or more radar alert devices 46 to output an alert signal. For instances, visual alert device 47 may output a visual alert signal, audio alert device 48 may output an audible alert signal, and/or vibrational alert device 49 may output a vibrational alert signal. In some examples, controller 58 may cause communication device 62 to output a message to one or more computing devices 10 indicating that WRDD 40 has received radar signals 7.

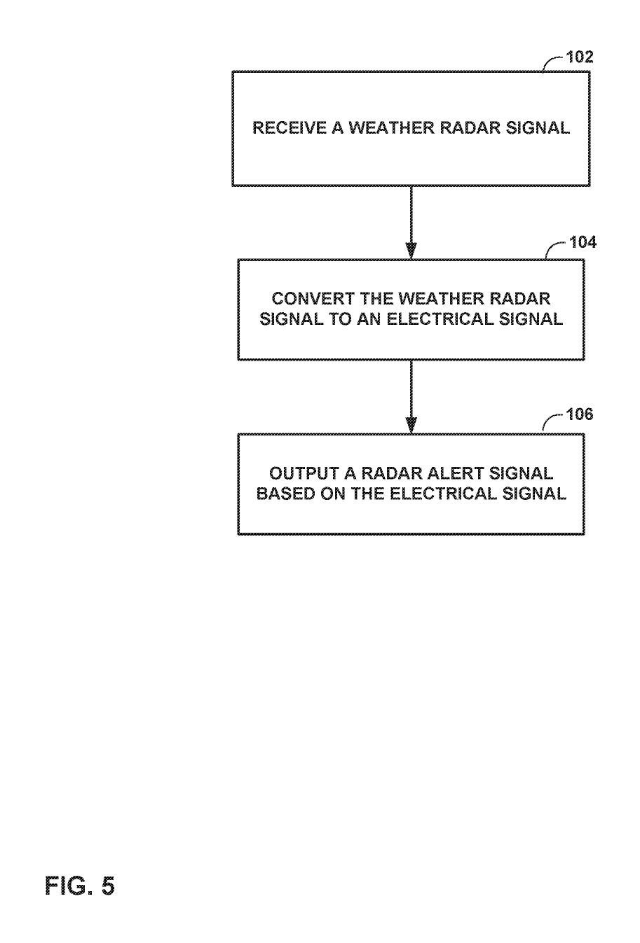

FIG. 5 is a flowchart illustrating an example method for detecting weather radar, in accordance with various aspects of this disclosure. For purposes of illustration only, the example method will be described with reference to the wearable radar detection device 20 described in FIG. 2. However, the method may apply to other radar detection devices.

In some examples, one or more radar antennas 22 may receive a weather radar signal (102). The one or more radar antennas 22 may convert the radar signal 7 to an AC electrical signal (e.g., AC voltage or current) (104) and may output the AC electrical signal. One or more radar processing devices 24 may receive the AC electrical signal. In some examples, the one or more radar processing devices 24 may amplify the AC electrical signal and/or convert the AC electrical signal to a DC electrical signal.

One or more radar alert devices 26 may output an alert signal based on the electrical signal (106). In some examples, one or more radar alert devices 26 may receive a DC electrical signal from one or more radar processing devices 24 and may output an alert signal (e.g., a visual alert signal, an audio alert signal, and/or a vibrational alert signal). In other examples, one or more radar processing devices 24 may include a controller which may cause the one or more radar processing device 24 to output an alert signal. In some examples, a controller may cause one or more communication devices to transmit a message to a remote computing device causing the computing device to output an alert signal indicating that an aircraft WXR system is still active and transmitting radar signals 7.

The techniques of this disclosure may be implemented in a wide variety of computer devices including as part of an integrated circuit (IC) or a set of ICs (e.g., a chip set). Any components, modules or units have been described provided to emphasize functional aspects and does not necessarily require realization by different hardware units. The techniques described herein may also be implemented in hardware, software, firmware, or any combination thereof. Any features described as modules, units or components may be implemented together in an integrated logic device or separately as discrete but interoperable logic devices. In some cases, various features may be implemented as an integrated circuit device, such as an integrated circuit chip or chipset. Moreover, components that have been described above as being separate or discrete may in fact be highly integrated.

Various examples have been described. These and other examples are within the scope of the following claims.

1. An actively powered wearable weather radar detection device comprising:
a battery;
at least one microstrip antenna configured to:
receive a weather radar signal from an airplane;
convert the weather radar signal into an AC electrical signal; and
output the AC electrical signal;
at least one processing circuit electrically coupled to the microstrip antenna and the battery, wherein the at least one processing circuit comprises:
a bandpass filter configured to attenuate electrical signals having a frequency that is not within a predetermined range of frequencies;
an amplifier configured to amplify a magnitude of the AC electrical signal;
a root-mean-squared (RMS) power detector configured to convert the amplified AC electrical signal to a DC electrical signal; and
an AD comparator configured to convert the DC electrical signal to a digital value and output a digital value; and
a microcontroller electrically configured to:
receive the digital value;
determine, based on the electrical signal digital value, whether to output an alert signal; and
responsive to determining to output an alert signal, send a command signal to an alert device causing the alert device to output the alert signal.

2. The actively powered wearable weather radar detection device of claim 1, wherein the alert device comprises a light source electrically coupled to the battery and the microcontroller, wherein the light source is configured to:
receive the command signal; and
output, based on the command signal, a visual alert signal visible by a person within the airplane,
wherein the alert signal comprises the visual alert signal.

3. The actively powered wearable weather radar detection device of claim 1, wherein the alert device comprises a speaker electrically coupled to the battery and the microcontroller, wherein the speaker is configured to:
receive the command signal; and
output, based on the command signal, an audible alert signal,
wherein the alert signal comprises the audible alert signal.

4. The actively powered wearable weather radar detection device of claim 1, wherein the alert device comprises a vibrational alert device electrically coupled to the battery and the microcontroller, wherein the vibrational alert device is configured to:
receive the command signal; and
output, based on the command signal, a vibrational alert signal,
wherein the alert signal comprises the vibrational alert signal.

5. The actively powered wearable weather radar detection device of claim 1, further comprising a communication device electrically coupled to the battery and the microcontroller,
wherein the communication device is configured to send, to a remote computing device and based on the electrical signal, a message causing the remote computing device to output an alert signal.

6. (canceled)

7. The actively powered wearable weather radar detection device of claim 1, further comprising:
an RFID antenna; and
an RFID processing circuit electrically coupled to the RFID antenna,
wherein the RFID antenna is configured to receive electromagnetic energy from an RFID reader, provide the electromagnetic energy to the RFID processing circuit, and output information from the RFID processing circuit.

8. The actively powered wearable weather radar detection device of claim 1, wherein the at least one microstrip antenna includes a first microstrip antenna configured to receive X-band radio wave and a second microstrip antenna configured to receive a radar signal in a radar band other than the X-band.

9. The actively powered wearable weather radar detection device of claim 1, wherein the at least one microstrip antenna comprises an ultra-wideband antenna configured to receive radar signals from multiple radar bands.

10. A passively powered wearable weather radar detection device comprising:
at least one microstrip antenna configured to:
receive a weather radar signal from an airplane; p2 convert the weather radar signal into an AC voltage;
output the AC voltage; and
at least one processing circuit electrically coupled to the at least one microstrip antenna and a light source, wherein the at least one processing circuit comprises an N-stage voltage multiplier configured to convert the AC voltage to a DC voltage that is approximately N-times a peak of the AC-voltage, wherein N is an integer greater than or equal to two; and
a light source electrically coupled to the at least one microstrip antenna via the at least one processing circuit, wherein the light source is configured to:
receive the DC voltage; and
output, based on the DC voltage, a light visible by a person within the airplane,
wherein the light source is powered solely by the DC voltage.

11. (canceled)

12. The passively powered wearable weather radar detection device of claim 10, wherein a luminosity of the light source is proportional to an amount of energy of the received weather radar signal.

13. The passively powered wearable weather radar detection device of claim 10, further comprising:
a speaker electrically coupled to the at least one microstrip antenna,
wherein the speaker is configured to output, based on the DC voltage, an audible alert signal,
wherein the speaker is powered solely by the DC voltage.

14. The passively powered wearable weather radar detection device of claim 10, further comprising:
an RFID antenna; and
an RFID processing circuit electrically coupled to the RFID antenna,
wherein the RFID antenna is configured to receive electromagnetic energy from an RFID reader, provide the electromagnetic energy to the RFID processing circuit, and output information from the RFID processing circuit.

15. The passively powered wearable weather radar detection device of claim 10, wherein the at least one microstrip antenna includes a first microstrip antenna configured to receive X band radio waves and a second microstrip antenna configured to detect a radar signal in a radar band other than the X-band.

16. The passively powered wearable weather radar detection device of claim 10, wherein the at least one microstrip antenna comprises an ultra-wideband radar antenna configured to receive radar signals from multiple radar bands.

17. A method comprising:
receiving, by a microstrip antenna, a weather radar signal from an airplane;
converting, by the microstrip antenna, the weather radar signal into an AC electrical signal;
outputting, by the microstrip antenna, the AC electrical signal;
receiving, by at least one processing circuit electrically coupled to the microstrip antenna and the alert device, the AC electrical signal;
attenuating, by a bandpass filter of the at least one processing circuit, the AC electrical signals having a frequency that is not within a predetermined range of frequencies;
amplifying, by an amplifier of the at least one processing circuit, a magnitude of the AC electrical signal;
converting, by a root-mean-squared (RMS) power detector of the at least one processing circuit, the amplified AC electrical signal to a DC electrical signal;
converting, by an AD comparator of the at least one processing circuit, the DC electrical signal to a digital value;
receiving, by a microcontroller of the at least one processing circuit, the digital value;
determining, by the microcontroller and based on the digital value, whether to output an alert signal; and
responsive to determining to output an alert signal, sending a command signal to an alert device causing the alert device to output the alert signal.

18. The method of claim 17, wherein the alert device comprises a light source electrically coupled to the battery and the microcontroller, the method further comprising:
receiving, by the light source, the command signal; and
outputting, by the light source and based on the command signal, a light visible by a person within the airplane.

19. The method of claim 17, wherein the alert device comprises a speaker electrically coupled to the battery and the microcontroller, the method further comprising:
receiving, by the speaker, the command signal; and
outputting, by the speaker and based on the command signal, an audible alert signal.

20. The method of claim 17, wherein the alert device comprises a communication device electrically coupled to the battery and the microcontroller, the method further comprising:
receiving, by the communication device, the command signal; and
sending, by the communication device and to a remote computing device, a message causing the remote computing device to output an alert signal.
